(19) United States
(12) Patent Application Publication
(10) Pub. No.: US 2003/0036599 A1
(43) Pub. Date: Feb. 20, 2003

(54) Rubber composition for tire

(76) Inventors: Makio Mori, Hiratsuka-shi (JP); Takeshi Hotaka, Hiratsuka-shi (JP)

Correspondence Address: Rader Fishman & Grauer, Suite 501, 1233 20th Street NW, Washington, DC, 20036, US

(21) Appl. No.: 10/204,091

(22) PCT Filed: Jan. 10, 2002
(86) PCT No.: PCT/JP02/00102

(30) Foreign Application Priority Data
Jan. 10, 2001 (JP) 2001-2919

(51) Int. Cl. C08K 3/04

(52) U.S. Cl. 524/496

(57) ABSTRACT

A rubber composition for a tire tread improved in frictional performance on ice. A rubber composition for a tire tread comprised of 100 parts by weight of a diene-based rubber and 1 to 30 parts by weight of an expanded graphite finished by being expanded by heat treatment.

### TECHNICAL FIELD

The present invention relates to a rubber composition for a tire tread, more particularly relates to a rubber composition for a tire tread obtained by blending expanded graphite, finished by being expanded by heat treatment, into a diene-based rubber to improve the frictional performance on ice.

### BACKGROUND ART

Numerous techniques for blending hard substances, foaming agents, hollow particles, etc. into rubber to create microlevel roughness on the surface and thereby remove the film of water formed on the surface of ice to improve the friction on ice have been studied and developed in the past. With these methods, however, generally the material of the additive is brittle, so there is the problem that in some cases part of the additive becomes reduced to a microlevel size or destroyed and the desired effect cannot be exhibited. Further, rubber compositions are known in which expanded graphite is blended for various purposes. For example, Japanese Unexamined Patent Publication (Kokai) No. 52-95645 discloses a rubber composition superior in electrical conductivity obtained by blending expanded graphite, expanded 20 to 500 times, in rubber, Japanese Unexamined Patent Publication (Kokai) No. 3-70754 discloses a rubber composition improved in heat conductivity obtained by blending expanded graphite treated on its surface by a titanate coupling agent in rubber, and Japanese Unexamined Patent Publication (Kokai) No. 10-195251 discloses a fire resistant rubber composition obtained by blending neutralized heat expanded graphite. No cases of use of such expanded graphite for a tire rubber composition for the purpose of enhancing the frictional performance on ice are yet known except for the prior invention of the present inventors (Japanese Patent Application No. 2000-223349).

### DISCLOSURE OF THE INVENTION

The object of the present invention is to provide a rubber composition for a tire tread superior in frictional performance on ice.

According to the present invention, there is provided a rubber composition for a tire tread comprised of 100 parts by weight of a diene-based rubber and 1 to 30 parts by weight of an expanded graphite finished by being expanded by heat treatment.

Further, according to the present invention, there is provided a rubber composition for a tire tread further comprising 1 to 20 parts by weight, with respect to the diene-based rubber, of unexpanded expandable graphite of a particle size of 20 to 600 μm or microcapsules expanding by heat to form a gas-filled thermoplastic resin.

Further, according to the present invention, there is provided a rubber composition for a tire tread using a diene-based rubber having a glass transition temperature of a mean value of not more than −55° C. or a rubber composition for a tire tread obtained by blending 20 to 80 parts by weight, with respect to 100 parts by weight of a diene-based rubber, of carbon black having an N₂SA of not less than 70 m²/g and a DBP absorption of at least 95 m1/100 g and further by blending 0 to 50 parts by weight of precipitated silica.

### BEST MODE FOR WORKING THE INVENTION

Graphite has a structure of superposed layers of graphite. Expandable graphite is graphite having an expandable substance inserted between the layers. Expandable graphite normally has a particle size of 30 to 600 μm and is commercially available. After heat-treatment, in this expandable graphite, the spaces between layers widen due to the expansion of the vaporized substance contained between the layers. The graphite expands by behavior like that of a rising curve and becomes irreversibly expanded. The structure of the layer of the expanded graphite is hard graphite. This graphite structure is held to a certain extent even in the face of a dynamic load. Therefore, even when mixing and kneading such an expanded graphite expanded once into the rubber, the expanded structure of the graphite is held, and a suitable roughness is formed on the surface of the vulcanized rubber. This results in an improvement in the frictional force between the rubber and ice of a snow tire (microlevel water expelling effect at tire surface).

As the method of improving the frictional force between rubber and ice of a snow tire by expanded graphite, other than the method of causing expandable graphite to expand in the process of vulcanization of the rubber composition containing the unexpanded expandable graphite for a tire as shown in the prior invention (Japanese Patent Application No. 2000-223349), the means may be considered of causing the expandable graphite to expand during the mixing of the rubber composition or during the extrusion. If the expandable graphite is caused to expand during kneading or during extrusion, however, the specific gravity of the rubber composition will change greatly in the middle of the process and therefore processing defects will be caused, so this is not practical. The method of blending expanded graphite finished being expanded in advance as used in the present invention is free from any change in the specific gravity of the rubber composition during the process and more practically enables realization of an improvement in the frictional force between the rubber and ice in a snow tire.

Expanded graphite is used as a material for graphite products, so is readily available. Further, once the expansion treatment is finished, the vulcanization temperature of the rubber can be freely selected, regardless of the on-set expansion temperature of the expandable graphite used. This is very convenient. Further, since no further expansion treatment is required in processing the rubber, there is also the merit that it is easier to use than unexpanded expandable graphite. Further, expanded graphite has a good affinity with the rubber matrix or carbon black since it has a skeletal structure comprised of carbon atoms. Even if blended into rubber, the abrasion resistance performance of the vulcanized rubber is also not reduced.

As shown in the prior invention (Japanese Patent Application No. 2000-223349), in a method of causing the expandable graphite to expand when vulcanizing a rubber composition including unexpanded expandable graphite for a tire, the expansion starting temperature of the expandable graphite material has to be higher than the maximum temperature applied to the rubber composition during kneading or extrusion of the rubber composition and lower than the processing temperature in the process of vulcanization of the tire. In practice, about 190° C. is the upper limit. The most general expandable graphite, however, is a strong acidic substance such as an anhydride of sulfuric acid inserted between the layers. The boiling point of the interlayer substance is 290° C., so the expansion starting temperature of the expandable graphite is a higher temperature. Therefore, the expandable graphite used in the prior invention (Japanese Patent Application No. 2000-223349) has to be a special material reduced in expansion starting temperature by use of a hydrate of sulfuric acid or use of a strong acidic substance other than sulfuric acid for the interlayer substance or other improvement. The expanded graphite used in the present invention is already finished expanding before being blended into the rubber. The temperature conditions for causing expansion of the expandable graphite can be freely selected, so there is no limitation on the selection of the expandable graphite material.

As the rubber ingredient able to be used for the diene-based rubber according to the present invention, any diene-based rubber conventionally used for tires in the past, for example, natural rubber (NR), various polybutadiene rubbers (BR), various styrene-butadiene copolymer rubbers (SBR), polyisoprene rubber (IR), acrylonitrile-butadiene rubber, chloroprene rubber, ethylene-propylene-diene copolymer rubber, styrene-isoprene copolymer rubber, styrene-isoprene-butadiene copolymer rubber, isoprene-butadiene copolymer rubber, etc. may be mentioned. When used as a tire tread of the present invention, the diene-based rubber used is preferably one having a glass transition temperature (Tg) of a mean value of not more than −55° C. so as to achieve and improve all of the low rolling resistance, abrasion resistance, and low temperature performance.

The expanded graphite finished by being expanded by heat treatment and blended in the present invention is preferably one obtained by using expandable graphite having a particle size before heat treatment of 100 to 350 μm and heat treating it to cause it to expand 300 to 1500 fold by the volume expansion rate. With a volume expansion rate of less than 300 fold, sufficient pores are not obtained on the surface of the tire, while if over 1500 fold, the lamellar structure of the graphite is destroyed. In the present invention, 10 to 30 parts by weight, preferably 5 to 10 parts by weight, of the expanded graphite are blended into 100 parts by weight of the diene-based rubber. If the amount blended is less than 1 part by weight, the microlevel roughness on the surface of the vulcanized rubber is small, so a sufficient effect cannot be exhibited, while if over 30 parts by weight, there is a detrimental effect on the abrasion resistance of the tire.

In the present invention, preferably 1 to 20 parts by weight, preferably 5 to 10 parts by weight, of unexpanded expandable graphite of a particle size of 20 to 600 μm is blended into the diene-based rubber together with the expanded graphite. If the amount blended is less than 1 part by weight, the microlevel roughness on the surface of the vulcanized rubber is small, so a sufficient effect cannot be exhibited, while if over 30 parts by weight, there is a detrimental effect on the abrasion resistance of the tire.

The unexpanded expandable graphite used may be one known in the past. For example, a crystalline compound maintaining the lamellar structure of carbon obtained by treating natural flake graphite, thermally decomposable graphite, kish graphite, etc. by an inorganic acid such as concentrated sulfuric acid or nitric acid etc. and a strong oxidizing agent such as concentrated nitric acid, perchloric acid salt, permanganate salt, or bichromate salt etc. to produce a graphite interlamellar compound may be mentioned.

Further, in the present invention, preferably the composition further includes 1 to 20 parts by weight, more preferably 5 to 10 parts by weight, of microcapsules expanding by heat to form a gas-filled thermoplastic resin with respect to 100 parts by weight of the diene-based rubber. If the amount blended is too small, the desired effect cannot be obtained, so this is not preferable. Conversely, if too great, a drop in the abrasion resistance occurs, so this is also not preferable.

The microcapsules expanding due to the above heat to form the gas-filled thermoplastic resin are particles comprised of a liquid which vaporizes, decomposes, or chemically reacts by heat to generate a gas enclosed in a thermoplastic resin. The microcapsules expand by heating at a temperature of at least the expansion starting temperature, normally a temperature of 140 to 190° C., and form microcapsules with gas filled in a shell comprised of a thermoplastic resin. The particle size of the microcapsules when not yet expanded is preferably 5 to 300 μm, more preferably 10 to 200 μm.

As such microcapsules (unexpanded particles), for example, currently the products named “Expancel 091DU-80” or “Expancel 092DU-120” etc. from Sweden's Expancel Co. or the products named “Matsumoto Microspheres F-85” or “Matsumoto Microspheres F-100” etc. from Matsumoto Yushi Co. are commercially available.

As the thermoplastic resin forming the shell ingredient of the microcapsules, preferably one having an expansion starting temperature of at least 100° C., preferably at least 120° C., and a maximum expansion temperature of at least 150° C., preferably at least 160° C., is preferably used. As such a thermoplastic resin, for example, a polymer of (meth)acrylonitrile or a copolymer having a high (meth)acrylonitrile content is suitably used. As another monomer (comonomer) in the case of a copolymer, a halogenated vinyl, a halogenated vinylidene, a styrene-based monomer, a (meth)acrylate-based monomer, vinyl acetate, butadiene, vinylpyridine, chloroprene, or another monomer is used. Note that the above thermoplastic resin may be made cross-linkable by a cross-linking agent such as divinylbenzene, ethyleneglycol di(meth)acrylate, triethyleneglycol di(meth)acrylate, trimethylolpropane tri(meth)acrylate, 1,3-butyleneglycol di(meth)acrylate, allyl(meth)acrylate, triacryl formal, and triallyl isocyanulate. As the cross-linking mode, non-cross-linking is preferable, but partial cross-linking to an extent not impairing the properties as a thermoplastic resin may also be performed.

As the liquid for vaporizing, decomposing, or chemically reacting due to the above heat to generate a gas, for example, a liquid such as a hydrocarbon such as n-pentane, isopentane, neopentane, butane, isobutane, hexane, and petroleum ether or a chlorinated hydrocarbon such as methyl chloride, methylene chloride, dichloroethylene, trichloroethane, and trichloroethylene may be mentioned.

In the rubber composition of the present invention, any carbon black ordinarily blended into a rubber composition may be blended as a rubber reinforcing agent. Further, carbon black treated on its surface with silica may also be used. Further, silica may also be used. As the amount of carbon black blended, 20 to 80 parts by weight, preferably 30 to 60 parts by weight, are used with respect to 100 parts by weight of the rubber ingredient. If the amount blended is too small, the rubber cannot be sufficiently reinforced so, for example, the abrasion resistance deteriorates. Therefore this is not preferable. Conversely, if too great, the hardness becomes too high or the processability falls, so this is also not preferable. Further, precipitated silica is blended into 100 parts by weight of the rubber ingredient in an amount of 0 to 50 parts by weight. Silica does not have to be used. If used, it should be used in an amount of blending of a range in where the tanδ balance is improved. If this is too great, the electrical conductivity falls or the cohesive power of the reinforcing agent becomes strong and dispersion during the mixing becomes insufficient, so this is not preferable.

The carbon black used in the present invention has a specific surface area by nitrogen adsorption (N₂SA) of at least 70 m²/g, preferably 80 to 200 m²/g, and a dibutyl phthalate absorption (DBP) of at least 95 m1/100 g, more preferably 110 to 140 m1/100 g.

In the rubber composition for a tire tread of the present invention, an ordinary vulcanization or cross-linking agent, vulcanization or cross-linking accelerator, various types of oils, anti-aging agent, filler, plasticizer, and other various additives generally blended for general rubber may be formulated. These formulations may be kneaded and vulcanized by general methods to obtain compositions and then vulcanized or cross-linked. The amounts of these additives blended may be made the conventional general amounts blended in so far as the object of the present invention is not contravened.

### EXAMPLES

Below, the present invention will be explained in further detail with reference to examples and comparative examples, but the scope of the present invention is of course not limited to these examples.

### Comparative Examples 1 to 3 and Examples 1 to 3

Preparation of Samples

In accordance with each formulation shown in the following Table 1 (parts by weight), rubber, carbon black, and other compounding agents were mixed for 5 minutes using a 1.7 liter closed Bambury mixer, then the vulcanization accelerator, sulfur, microcapsules, expandable graphite, and expanded graphite were blended by an open mill. Next, this composition was press vulcanized in a 15 cm×15 cm×0.2 cm mold at 175° C. for 10 minutes and at 150° C. for 45 minutes to prepare the targeted test piece (rubber sheet). The frictional force on ice (−3° C. and −1.5° C.) was measured and evaluated as the vulcanized physical property.

Measurement of Frictional Force on Ice

Sheets obtained by vulcanizing the compounds were adhered to flat cylindrically shaped rubber backings and then measured for frictional coefficient on ice by an inside drum type ice friction tester. The measurement temperature was −3.0° C. and −1.5° C., the load 5.5 kg/cm², and the drum rotational speed 25 km/h.

The results are shown in Table 1. The larger the index, the higher the frictional force on ice.

TABLE 1

| | Comp. | | Comp. | | Comp. | |
|---|---|---|---|---|---|---|
| Formulation | Ex. 1 | Ex. 1 | Ex. 2 | Ex. 2 | Ex. 3 | Ex. 3 |
| Natural rubber RSS#3 | 50 | 50 | 50 | 50 | 50 | 50 |
| Nipol 1220*1 | 50 | 50 | 50 | 50 | 50 | 50 |
| Shoblack N220*2 | 55 | 55 | 55 | 55 | 55 | 55 |
| Santoflex 6PPD*3 | 1 | 1 | 1 | 1 | 1 | 1 |
| Zinc Oxide No. 3*4 | 3 | 3 | 3 | 3 | 3 | 3 |
| Stearic acid*5 | 1 | 1 | 1 | 1 | 1 | 1 |
| Aromatic oil*6 | 30 | 30 | 30 | 30 | 30 | 30 |
| Santocure NS*7 | 1.5 | 1.5 | 1.5 | 1.5 | 1.5 | 1.5 |
| Sulfur*8 | 2 | 2 | 2 | 2 | 2 | 2 |
| Microspheres | | | 10 | 10 | | |
| F100D*9 | | | | | | |
| GRAF Guard | | | | | 10 | 10 |
| 160-50N*10 | | | | | | |
| Expanded graphite*11 | | 10 | | 10 | | 10 |
| Experimental findings | | | | | | |
| Vulcanization at | | | | | | |
| 170° C. for 15 minutes | | | | | | |
| Frictional force on ice | 100 | 115 | 112 | 126 | 115 | 130 |
| −3.0° C. (index) | | | | | | |
| Frictional force on ice | 100 | 119 | 120 | 137 | 118 | 142 |
| −1.5° C. (index) | | | | | | |
| Vulcanization at | | | | | | |
| 150° C. for 45 minutes | | | | | | |
| Frictional force on ice | 100 | 113 | 104 | 116 | 98 | 133 |
| −3.0° C. (index) | | | | | | |
| Frictional force on ice | 100 | 120 | 106 | 125 | 100 | 119 |
| −1.5° C. (index) | | | | | | |

(Note)
*1. BR made by Nippon Zeon, Tg = −101° C.
*2. Carbon black made by Showa Cabot (N₂SA: 111 m²/g, DBP absorption: 111 ml/100 g)
*3. Antioxidant made by Flexsis
*4. Made by Seido Chemical Industry
*5. Made by NOC
*6. Made by Fuji Kosan
*7. Vulcanization accelerator made by Flexsis
*8. Made by Karuizawa Refinery
*9. Heat expandable microcapsules made by Matsumoto Yushi
*10. Unexpanded expandable graphite made by UCAR Graphtech (marketed by Tomoe Industry) (expansion starting temperature 160° C.)
*11. Expanded graphite obtained by expanding unexpanded expandable graphite of *10 at about 300° C.

According to Table 1, in Comparative Examples 2 and 3, rubbers press vulcanized at 150° C. for 45 minutes are not improved in frictional force on ice since the heat expandable microcapsules and unexpanded expandable graphite do not sufficiently expand during vulcanization. As opposed to this, the expanded graphites shown in Examples 1, 2, and 3 have high frictional forces on ice regardless of the press vulcanization conditions.

Industrial Applicability

As explained above, according to the present invention, it is learned that by blending expanded graphite or this plus microcapsules expanding by heat to form a gas-filled thermoplastic resin or unexpanded expandable graphite into a diene-based rubber, the frictional performance on ice of a vulcanized rubber is remarkably improved. Therefore, such a rubber composition is useful as a rubber composition for a tire tread.

1. A rubber composition for a tire tread comprised of 100 parts by weight of a diene-based rubber and 1 to 30 parts by weight of an expanded graphite finished by being expanded by heat treatment.

2. A rubber composition as claimed in claim 1, further comprising 1 to 20 parts by weight, with respect to the diene-based rubber, of unexpanded expandable graphite of a particle size of 20 to 600 μm.

3. A rubber composition as claimed in claim 1 or 2, further comprising 1 to 20 parts by weight, with respect to the diene-based rubber, of microcapsules expanding by heat to form a gas-filled thermoplastic resin.

4. A rubber composition as set forth in any one of claims 1 to 3, wherein a glass transition temperature of said diene-based rubber has a mean value of not more than −55° C.

5. A rubber composition for a tire tread, as set forth in any one of claims 1 to 4, obtained by blending 20 to 80 parts by weight, with respect to 100 parts by weight of a diene-based rubber, of carbon black having a N₂SA of not less than 70 m²/g and a DBP absorption of at least 95 m1/100 g and 0 to 50 parts by weight of precipitated silica.
